(19) United States
(12) Patent Application Publication
(10) Pub. No.: US 2023/0092580 A1
(43) Pub. Date: Mar. 23, 2023

(54) METHOD FOR HIERARCHICAL CLUSTERING OVER LARGE DATA SETS USING MULTI-OUTPUT MODELING

(71) Applicant: CIVIS ANALYTICS, INC., Chicago, IL (US)

(72) Inventors: Elizabeth Sander, Chicago, IL (US); Jonathan Seabold, Chicago, IL (US); Caitlin Malone, Chicago, IL (US)

(21) Appl. No.: 17/618,418

(22) PCT Filed: Jun. 10, 2020
(86) PCT No.: PCT/US20/36999

§ 371 Date: Dec. 10, 2021

Related U.S. Application Data
(60) Provisional application No. 62/859,594, filed on Jun. 10, 2019.

(51) Int. Cl. G06N 20/20

(52) U.S. Cl. CPC G06N 20/20

(57) ABSTRACT

A method for hierarchical clustering includes receiving a large set of data, training an algorithm to find patterns in the received data that most accurately predict the outcomes, and generating a multi-output model to maximize the cluster quality of a set of features. The data include at least two binary drivers and one binary need, the drivers predict the value of the need, and the data include at least two outcomes.

### CROSS-REFERENCE TO RELATED APPLICATION

This application claims priority from U.S. Provisional Patent Application Ser. No. 62/859,594, filed Jun. 10, 2019, which is incorporated herein by reference in its entirety.

### BACKGROUND

BIRCH (Balanced Iterative Reducing and Clustering using Hierarchies) is a data clustering method used on very large databases or data sets. See Tian Zhang et al., “BIRCH: an efficient data clustering method for very large databases,” Proceedings of the 1996 ACM SIGMOD International Conference on Management of Data—SIGMOD '96, 25 ACM SIGMOD Record 103-114 (June 1996). It is an unsupervised data mining algorithm that performs hierarchical clustering over these databases or data sets. Data clustering involves grouping a set of objects based on their similarity of attributes and/or their proximity in the vector space. BIRCH is able to incrementally and dynamically cluster incoming, multi-dimensional metric data points in an attempt to produce the best quality clustering for a given set of resources (memory and time constraints). In most cases, BIRCH requires only a single scan of a database or data set. BIRCH is considered to effectively manage “noise,” defined as “data points that are not part of the underlying pattern.” Id. at 103.

With BIRCH, each clustering decision is made without scanning all data points and currently existing clusters. It exploits the observation that data space is not usually uniformly occupied and not every data point is equally important. Id. at 105.

FIG. 1 shows a process flow for BIRCH. Id. at 107. Clustering features (“CF”) of the data points are organized in a CF tree, a height-balanced tree with two parameters: branching factor B and threshold T. Each non-leaf node contains at most B entries of the form [CFᵢ, childᵢ], where child; is a pointer to its ith child node and CFᵢ is the clustering feature representing the associated subcluster. A leaf node contains at most L entries each of the form [CFᵢ]. It also has two pointers prev and next that are used to chain all leaf nodes together. The tree size depends on the parameter T. A node is required to fit in a page of size P. B and L are determined by P. So P can be varied for performance tuning. It is a very compact representation of the data set because each entry in a leaf node is not a single data point but a subcluster.

In the second step, the BIRCH algorithm scans all the leaf entries in the initial CF tree to rebuild a smaller CF tree, while removing outliers and grouping crowded subclusters into larger ones.

In step three, a clustering algorithm is used to cluster all leaf entries. An agglomerative hierarchical clustering algorithm may be applied directly to the subclusters represented by their CF vectors. It also provides the flexibility of allowing the user to specify either the desired number of clusters or the desired diameter threshold for clusters. After this step, a set of clusters is obtained that captures major distribution patterns in the data.

There may be minor and localized inaccuracies that can be handled by an optional step 4. In step 4, the centroids of the clusters produced in step 3 are used as seeds and redistribute the data points to its closest seeds to obtain a new set of clusters and discard outliers. A point that is too far from its closest seed can be treated as an outlier.

Prior systems use a clustering method to determine relative feature importances within a set of categorical variables, which are then used to build the CF tree. The leaves of this tree are then evaluated by the user based on how well they cluster a set of (continuous) attitudinal variables. Users generally iteratively build and evaluate trees, to find a set of leaves that both make business sense and are supported by the data.

### BRIEF DESCRIPTION OF THE DRAWINGS

FIG. 1 shows a process flow for BIRCH;

FIG. 2 shows a decision tree generated by an embodiment of the present invention; and

FIG. 3 shows a chart that provides a graphical representation of the decision tree in FIG. 2, according to an embodiment of the present invention.

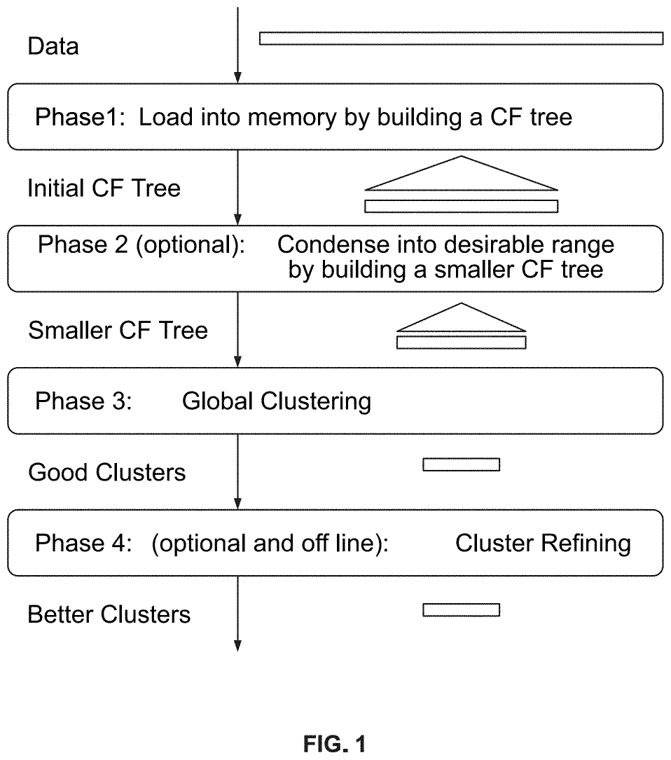

### DETAILED DESCRIPTION

The following disclosure provides different embodiments, or examples, for implementing different features of the subject matter. Specific examples of components and arrangements are described below to simplify the present disclosure. These are, of course, merely examples and are not intended to be limiting.

This present method and system provide for hierarchical clustering over large data sets using multi-output modeling. The present system and method calculate feature importances and build the final CF tree, which produces significantly better leaves (microspaces) than the clustering approach described above. Unlike prior approaches, the present system and method build a decision tree based on a first set of features to maximize the cluster quality of a second set of features.

The present method uses a supervised algorithm, rather than an unsupervised algorithm as used in prior systems. Unsupervised algorithms are often used for segmentation and clustering, because there is not a “correct” answer to these problems: instead, they're judged by whether they “look right” or “make sense” (usually according to some hard-to-define business rules or intuition). Supervised algorithms, in contrast, are used in contexts in which there are data showing both inputs and outcomes, and the algorithm is trained to find the patterns in the input data that most accurately predict the outcomes.

In general, supervised algorithms have a notion of “right” and “wrong” answers and may be explicitly optimized to get things “right” as much as possible. A decision tree is a type of supervised algorithm and is a basis for the present method and system. Briefly, a decision tree is a binary tree with yes/no criteria based on the input variables at each node, and the leaves (microspaces) are effectively predictions of outcomes. The variables, and split values, at the nodes are determined automatically by the algorithm. A good decision tree is one in which the leaves (microspaces) are as pure as possible with respect to the outcome of interest.

To build intuition, there is a set of several binary drivers and one binary need in the data set. The present decision-tree model uses the drivers to predict the value of the need. The present system and method find splits along the binary variable that maximize the purity of each leaf (microspace) with respect to the need—each microspace will be as purely one class or another as possible. Put another way, each microspace is optimized to spike one way or another with respect to that need. A spike is a difference in the average value of the need in the microspace as compared to the general population. A decision tree will produce leaves where individuals with especially high or low values for a need will tend to be clustered together; thus the leaves will tend to spike with respect to the need.

The present system uses a multi-output model, which models many outcomes all at the same time. Attitudinal variables describe the segments (e.g., microspaces)—each attitudinal variable is an outcome in the present system. The type of model depends on the type of attitudinal data: if the attitudinal data are binary or categorical, the present system creates a classification model; if the attitudinal data are continuous, the present system creates a regression model instead. Third, the present system recommends a split at each node (the user can accept the algorithm's suggestion or pick a plausible alternative), with autobuild as an optional setting. A single output decision tree model will create splits that maximize the purity of leaves for a single output (in this case, an attitudinal variable). A multi-output model generalizes this by maximizing the purity of all leaves for all attitudinal variables. Whether it is single output or multi-output, the algorithm optimizes over a distance function; for a regression model, that may include mean-squared error. In this case, a multi-output model sums over the error for all attitudinal variables in the model, and splits on drivers that minimize this error term.

Fourth, to improve the stability of the tree (that is, to ensure the structure is not driven by individual outliers), each split node of the decision tree is a depth 1 (single split) random forest, which effectively creates a number of slightly different options and takes the consensus choice. With the present system, the random forest relates to bootstrapping over the data (sampling with replacement) and choosing a subset of features, then finding the best feature to split on based on that sample of data and features. The present system does this many times to achieve a stable estimate of feature importances (e.g., the feature importance is the percentage of the time a feature was chosen for splitting). By default, the present system splits on the feature with the highest importance. According to one embodiment, a user may configure the present system to use the feature importance alongside his/her business knowledge to make an informed decision about which feature to split on.

This minimizes the chance that a small number of points will significantly change the tree. Because the needs are modeled directly (e.g., actively optimizing the tree with respect to the needs, rather than building a tree and looking at how the needs spike after the fact), the model can directly choose categorical variables that result in larger “spikes” in the attitudinal variables. A threshold of 0.15 is used to determine which attitudinal variables spike in a given cluster. In preliminary tests using the decision tree approach, we see as many or more spikes when using a threshold of 0.3.

According to one embodiment, spiking is the mean within the cluster relative to the mean across the entire data set, and the thresholds themselves are chosen heuristically. When interpreting the clusters, it makes sense to choose a threshold such that at least a couple attitudinal variables spike for each cluster; these variables can then be thought of as the defining attitudes for the cluster (since they are the attitudes that most distinguish the cluster from the general population).

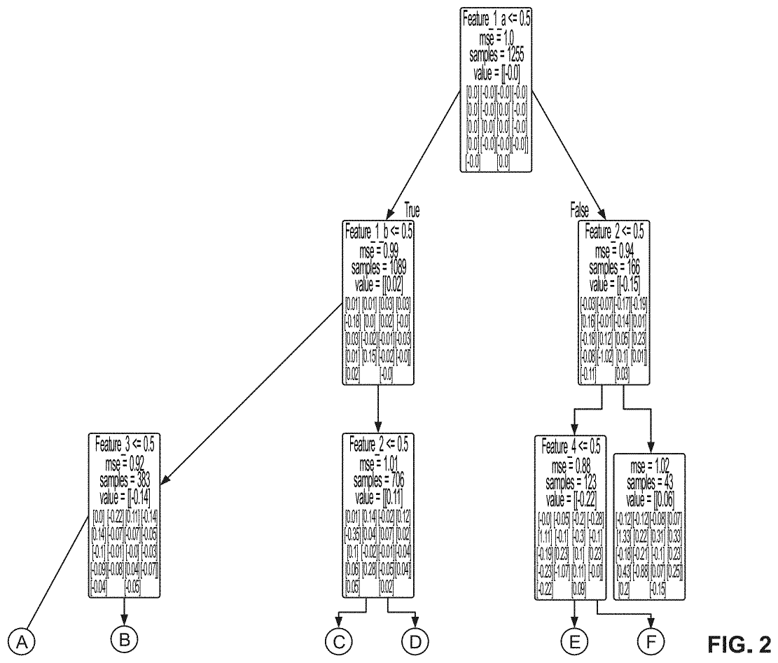

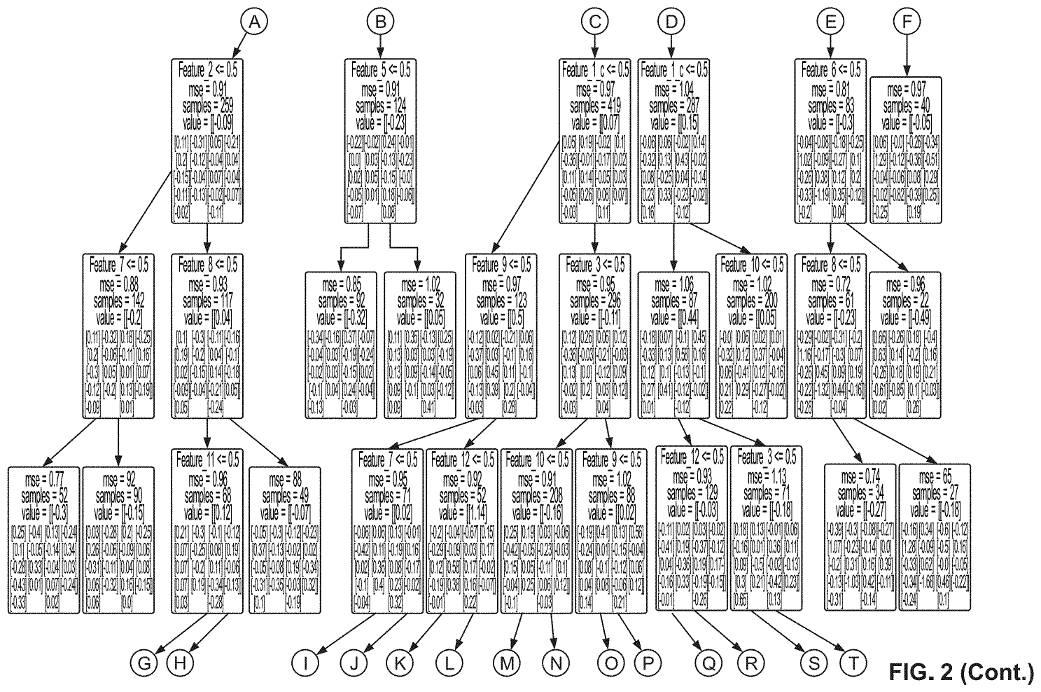

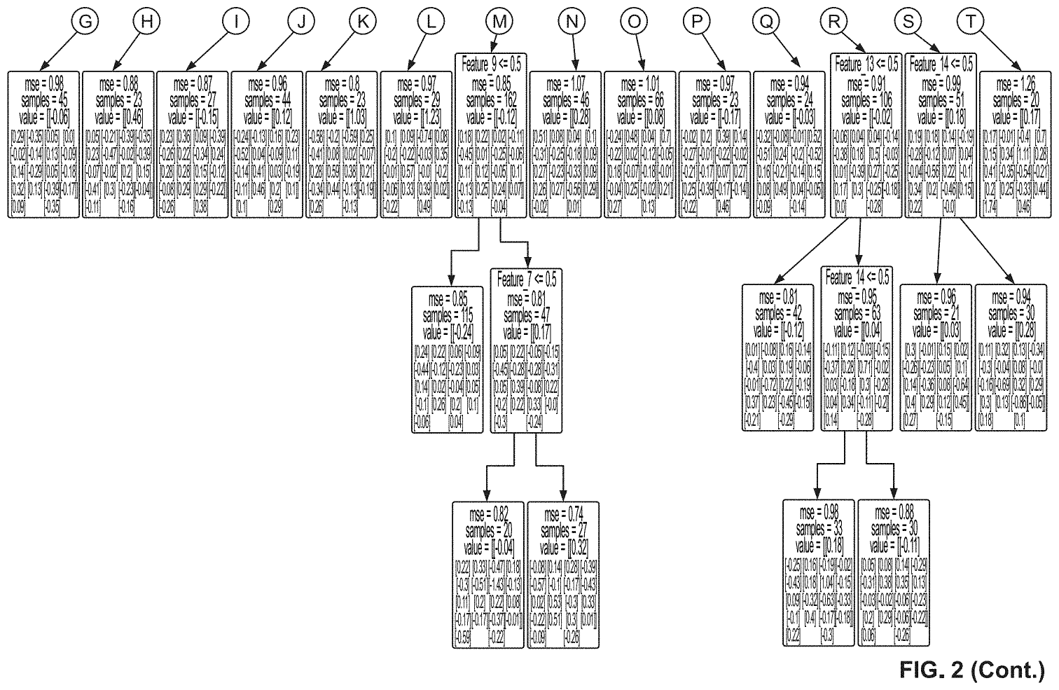

The present system generates a decision tree as described above and shown in FIG. 2.

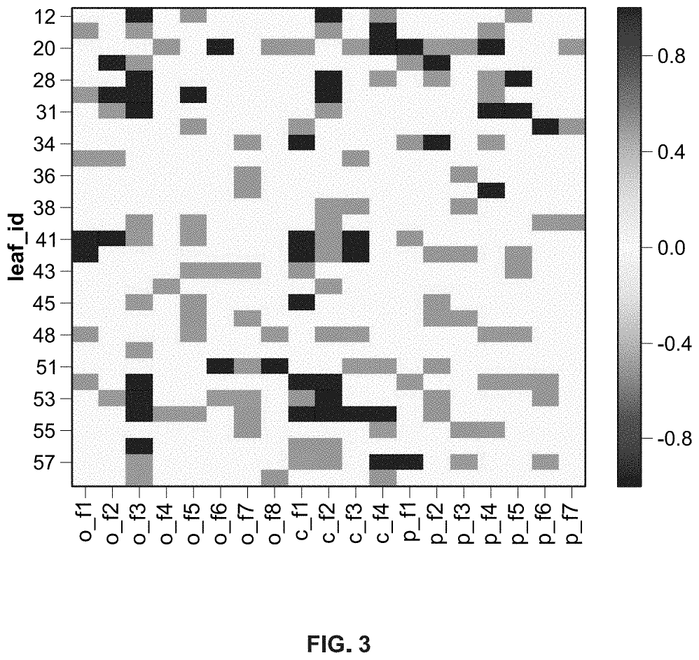

The present system generates a chart that provides a graphical representation of the decision tree, as shown in FIG. 3.

In the chart of FIG. 3, rows are clusters, columns are the features, and colors represent the level of spikiness. Light blue/red have a value of at least 0.3/(−0.3 for red), dark blue/red have a value of at least 0.5 (−0.5 for red). For example, the bottom row of FIG. 3 spikes on three attitudinal features. Let's assume the values are −0.3 for “concerned about convenience,” 0.3 for “wants the best deal,” and 0.3 for “concerned about debt.” This means that the customer cares a lot about saving money, but not very much about convenience.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated.

1. A method for hierarchical clustering, comprising:
receiving a large set of data comprising at least two binary drivers and one binary need, wherein the drivers predict the value of the need and the data comprise at least two outcomes;
training an algorithm to find patterns in the received data that most accurately predict the outcomes; and
generating a multi-output model to maximize the cluster quality of a set of features.

2. The method of claim 1, wherein the algorithm is supervised.

3. The method of claim 1, wherein the multi-output model is a decision tree.

4. The method of claim 3, wherein the decision tree comprises split nodes and each split node is a single split random forest.

5. The method of claim 4, wherein the random forest comprises sampling with replacement, choosing a subset of features, and finding the best feature to split on based on the sampling and subset of features.

6. The method of claim 1, wherein each outcome comprises an attitudinal variable.

7. The method of claim 6, wherein if the attitudinal variable is binary, the multi-output model comprises a classification model.

8. The method of claim 6, wherein if the attitudinal variable is categorical, the multi-output model comprises a classification model.

9. The method of claim 6, wherein if the attitudinal variable is continuous, the multi-output model comprises a regression model.

10. The method of claim 9, wherein the regression model comprises a mean-squared error distance function.

11. The method of claim 1, wherein the algorithm optimizes over a distance function.

12. The method of claim 1, further comprising using feature importance and a user's business knowledge to make an informed decision about which feature to split on.

13. A method for generating a multi-output model using hierarchical clustering, comprising:
receiving a large set of data comprising a plurality of features;
calculating the importance of each of the plurality of features;
selecting a first set and a second set of features from the plurality of features; and
generating, using a trained supervised algorithm, a multi-output model based on the first set of features to maximize the cluster quality of the second set of features.

14. The method of claim 13, wherein calculating the importance of a feature comprises:
repetitively sampling the data with replacement;
choosing a subset of features; and
finding the best feature to split on based on that sample of data and subset of features to achieve a stable estimate of feature importance.

15. The method of claim 14, wherein feature importance comprises the percentage of the time a feature is chosen for splitting.
